(19) United States
(12) Patent Application Publication
(10) Pub. No.: US 2023/0270168 A1
(43) Pub. Date: Aug. 31, 2023

(54) Evaporator Assembly

(71) Applicant: JT International SA, Geneva (CH)

(72) Inventors: Andrew Robert John Rogan, Forres (GB); Madoka Hasegawa, Nyon (CH)

(73) Assignee: JT International SA, Geneva (CH)

(21) Appl. No.: 18/006,767

(22) PCT Filed: Jul. 28, 2021
(86) PCT No.: PCT/EP2021/071222

§ 371 Date: Jan. 25, 2023

(30) Foreign Application Priority Data
Jul. 29, 2020 (EP) 20188452.5

(51) Int. Cl. A24F 40/46; A24F 40/10; A24F 40/48; A24F 40/50

(52) U.S. Cl. CPC A24F 40/46; A24F 40/10; A24F 40/48; A24F 40/50

(57) ABSTRACT

An evaporator assembly for a vapour generation device is described. The evaporator assembly comprises a deformable plate in which is formed a first plurality of channels for transporting a vaporisable liquid through the deformable plate to an outlet surface of the evaporator assembly, wherein the deformable plate is configured such that in use the cross-sectional area of each of the first plurality of channels varies as the deformable plate is deformed.

### FIELD OF THE INVENTION

The invention relates to vapour generation devices and, in particular, to an evaporator assembly for a vapour generation device.

### BACKGROUND

Vapour generation devices such as electronic cigarettes have become popular as substitutes for traditional means of tobacco consumption such as cigarettes and cigars.

Some vapour generation devices generate a vapour or aerosol from a vaporisable liquid. Different vapourisable liquids can have different properties (for example viscosity, density and volatility), which may be the result of the presence of different colourants, flavourings and other chemical components in the liquid. These different properties can affect the behaviour of the liquid under the conditions to which it is subjected in the vapour generation process, and this can affect the quality of the generated vapour, for example the size of the liquid droplets in the vapour, the temperature of the vapour and the overall rate at which the vapour is generated. To ensure an optimal user experience, it is desirable that the quality of the vapour generated by a vapour generation device is consistent between vapourisable liquids with different compositions and under different ambient conditions. There is thus a demand for vapour generation devices that enable a greater degree of control over the characteristics of the generated vapour than is achieved by current devices.

### SUMMARY OF THE INVENTION

A first aspect of the invention provides an evaporator assembly for a vapour generation device, the evaporator assembly comprising a deformable plate in which is formed a first plurality of channels for transporting a vaporisable liquid through the deformable plate to an outlet surface of the evaporator, wherein the deformable plate is configured such that in use the cross-sectional area of each of the first plurality of channels varies as the deformable plate is deformed.

The cross-sectional area of each of the first plurality of channels referred to herein is the area of the channel in the plane perpendicular to the direction along which the channel extends. This cross-sectional area influences the rate at which a vapourisable travels along the channel (in particular when this transport is driven by capillary action), so deforming the deformable plate can affect the rate at which the vapourisable liquid is transported to the outlet surface. This can in turn affect the rate at which the liquid is delivered to the outlet surface and the size of the droplets that are produced there. The deformable plate can thus be deformed in such a manner as to ensure consistency of particular characteristics of the generated vapour such as droplet size and flow rate. The deformable plate may be any structure, or assembly of structures, that provides a plurality of channels suitable for transporting the vaporisable liquid and is deformable in the manner defined above. In some embodiments the deformable plate may conveniently be provided as an integral structure shaped to define the first plurality of channels, though this is not essential. In some preferred embodiments, the outlet surface of the evaporator assembly is a surface of the deformable plate.

In order to enable control over the deformation of the deformable plate, the evaporator assembly preferably comprises an actuator arranged to deform the deformable plate when the actuator is operated. The actuator could be controlled by a microprocessor, for example. In particularly preferred embodiments, the actuator is configured to deform the deformable plate by one or more of stretching, compressing and shearing the deformable plate along a direction perpendicular to the first plurality of channels (i.e. along a direction perpendicular the direction along which the first plurality of channels extend). This prevents the dimensions of the deformable plate in the direction along which the liquid is transported from being altered, and can hence ensure that the position of the outlet surface (which can, in some embodiments, be a surface of the deformable plate) does not change as the deformable plate is deformed. This can be advantageous since it allows the outlet surface to be located at an optimum position for the generation of the vapour, for example inside an airflow channel in a vapour generation device. The actuator could, however, be configured to perform other modes of deformation as alternatives to, or in addition to, those listed above, for example by stretching the deformable plate along a direction parallel to the first plurality of channels.

In some preferred implementations, the first plurality of channels is defined by a cellular structure in the deformable plate, wherein preferably the cellular structure is one of a honeycomb, truss or kirigami-based cellular structure. The term “cellular structure” here signifies that each of the first plurality of channels is bounded by a wall of a substantially uniform thickness. This allows the deformable plate to deform in a substantially uniform manner when subjected to a deforming force. In a honeycomb structure, each of the channels has a hexagonal cross-section. A truss structure is defined by a plurality of intersecting straight lines, for example a square grid. A kirigami-based structure is one that is defined by one or more cuts in a planar sheet of material. Each cut defines a respective channel, and deforming the sheet alters the cross-sectional area of each channel.

In preferred embodiments, the first plurality of channels is arranged in a regular array. This helps to achieve a uniform rate of liquid transport across the extent of the plate. The regular array could be defined by a cellular structure: in a honeycomb structure, for example, the channels could be arranged in accordance with a triangular array. However, the first plurality of channels being arranged in a regular array does not necessarily result in the deformable plate having a cellular structure in the sense defined above. In other embodiments, the arrangement of the first plurality of channels may be non-regular.

Preferably each of the first plurality of channels is adapted to transport the liquid through the deformable plate by capillary action. The ability of the channels to transport the liquid by capillary action may depend on the contact angle between the liquid and the material from which the deformable plate is made (which may itself depend on the local temperature and pressure) and the dimensions of the channels. In other embodiments, the liquid may be transported through the first plurality of channels by other means, for example by gravity or by the application of pressure. In some preferred implementations, the diameter of the first plurality of channels in the direction perpendicular to each of the first plurality of channels may be less than the thickness of the deformable plate along the direction parallel to the first plurality of channels. This allows the first plurality of channels to be comparatively narrow, which promotes transport of the liquid by capillary action (which will be discussed in more detail later) and, where the deformable plate is deliberately heated (which will also be discussed in more detail below), also promotes heating of the liquid by the deformable plate as it passes through the first plurality of channels.

In preferred embodiments, the evaporator assembly comprises a first heater arranged to heat the deformable plate. Heating the deformable plate can affect the contact angle between the liquid and the material of the plate, and this in turn influences the rate at which the liquid is drawn through the deformable plate by capillary action (if the first plurality of channels are adapted to transport the liquid by capillary action). Heating the deformable plate can also affect the properties of the vapour generated by the evaporator assembly. In particularly preferred embodiments, the first heater comprises an electrical source configured to generate a current through the deformable plate so as to cause resistive heating of the deformable plate. The first heater could comprise an electronic control circuit that controls the current through the deformable plate, for example. However, the first heater could alternatively be configured to deliver heat to the deformable plate from a separate heat source.

The deformable plate and the first heater may be arranged such that the vaporisable liquid is heated as it is transported through the first plurality of channels. This is not essential, however: for example, the dimensions of the deformable plate may be such that the liquid is substantially not heated in the time that it takes to travel through the first plurality of channels. Heating the vaporisable liquid in this way can influence the properties of the generated vapour, since parameters such as the size of the droplets released at the outlet surface may depend on the temperature of the liquid.

In preferred embodiments, the evaporator assembly further comprises a rigid plate in which is formed a second plurality of channels for transporting the vaporisable liquid through the rigid plate, wherein the rigid plate and the deformable plate overlap one another such that the second plurality of channels is in fluid communication with the first array of channels. For example, the deformable plate could be disposed directly on a surface of the rigid plate. The presence of a rigid plate is advantageous as this feature provides support to the deformable plate and thus ensures that it deforms in the intended manner when subjected to a deforming force. The presence of a rigid plate between the liquid reservoir and the deformable plate also ensures that the size of the interface in contact with the liquid does not need to change in use, which avoids needing to adapt the reservoir such that the size of this interface can vary. The reservoir can hence be formed by a solid receptacle, for example, which does not need to adapt to the changing dimensions of the deformable plate.

Where the rigid plate is provided, the second plurality of channels is preferably adapted to transport the liquid through the rigid plate by capillary action. As discussed above with reference to the deformable plate, the ability of the second plurality of channels to transport the liquid by capillary action depends, among other facts, on the dimensions of the second plurality of channels and the material of which the rigid plate is formed.

In particularly preferred embodiments, the deformable plate is disposed directly on the rigid plate. However, in other embodiments additional structural features may be provided between the deformable and rigid plates.

Where the rigid plate is provided, the evaporator assembly further comprises a second heater arranged to heat the rigid plate. This provides additional control over the rate of transport of the liquid through the rigid plate (and hence through the evaporator assembly as a whole) as explained above with reference to the first heater. The second heater preferably comprises an electrical source configured to generate a current through the deformable plate so as to cause resistive heating of the deformable plate. For example, the second heater could comprise an electronic control circuit for controlling the current through the rigid plate.

A second aspect of the invention provides a vapour generation device comprising: an evaporator assembly in accordance with the first aspect of the invention; and a reservoir for storing the vaporisable liquid, wherein the evaporator assembly is arranged to receive the vaporisable liquid from the reservoir.

Preferably the evaporator further comprises a porous wick arranged to transport the liquid from the reservoir to the evaporator assembly.

### BRIEF DESCRIPTION OF THE DRAWINGS

Examples of evaporator assemblies and a vapour generation device in accordance with aspects of the invention will now be described with reference to the accompanying drawings, in which:

FIG. 1 is a cross-sectional view of an evaporator assembly in accordance with a first embodiment of the first aspect of the invention;

FIG. 2 is a perspective view of a first exemplary deformable plate suitable for use in embodiments of the invention;

FIG. 3 is a perspective view of a second exemplary deformable plate suitable for use in embodiments of the invention;

FIG. 4 is a perspective view of a third exemplary deformable plate suitable for use in embodiments of the invention;

FIG. 5 is a cross-sectional view of an evaporator assembly in accordance with a second embodiment of the first aspect of the invention; and

FIG. 6 shows schematically an embodiment of a vapour generation device in accordance with the second aspect of the invention.

### DETAILED DESCRIPTION

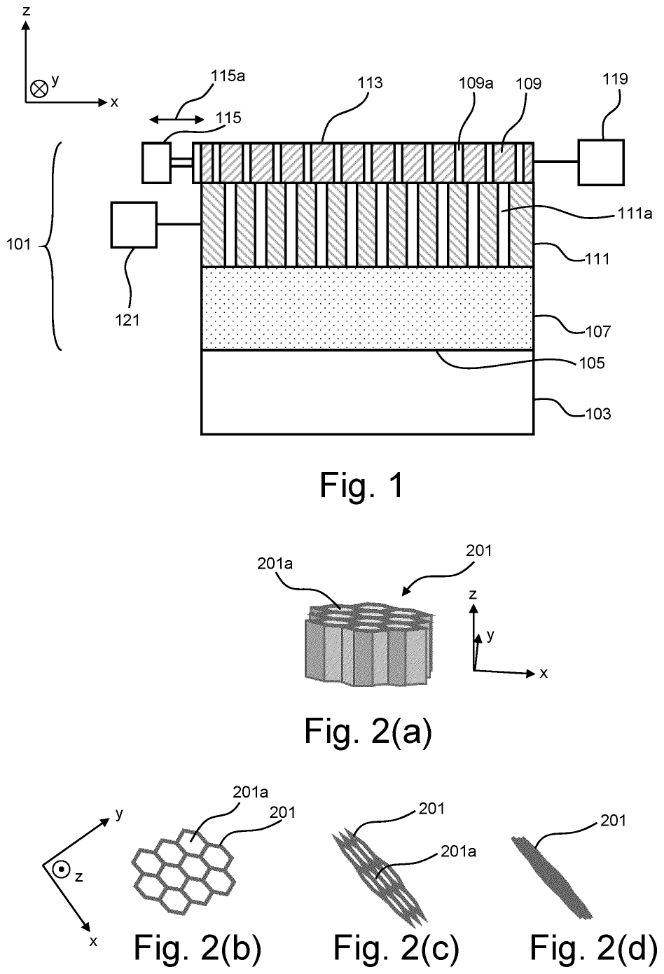

FIG. 1 is a cross-sectional view of an evaporator assembly 101 in accordance with a first embodiment of the first aspect of the invention. An inlet surface 105 of the evaporator assembly 101 is in contact with a reservoir 103 of a vapourisable liquid. The reservoir 103 could be part of a vapour generation device in accordance with the second aspect of the invention. In this example, the inlet surface 105 of the evaporator assembly 101 is a surface of a porous wick 107, which is made of a porous material suitable for absorbing the vapourisable liquid in the reservoir.

The evaporator assembly 101 includes a deformable plate 109 and a rigid plate 111. A first plurality of channels 109a extends through the deformable plate 109, and a second plurality of channels 111a extends through the rigid plate 111.

The rigid plate 111 is disposed on the porous wick 107. The second plurality of channels 111a extend parallel to one another along the z direction. In this example, the second plurality of channels 111a are regularly spaced from one another along the x direction. Each one of the second plurality of channels 111a is sufficiently narrow (i.e. has a sufficiently small cross-sectional area in the x-y plane) that when it receives the vapourisable liquid from the porous wick 107, the vapourisable liquid can travel along the channels 111a by capillary action.

The deformable plate 109 is disposed directly on the rigid plate 111. The first plurality of channels 109a extend along the z direction, parallel to one another, through the deformable plate 109. In use, the first plurality of channels 109a receive the vapourisable liquid from the rigid plate 111 when the vapourisable liquid is transported through the rigid plate 111 by capillary action as described above. The first plurality of channels 109a open onto an outlet surface 113 of the evaporator assembly, which is a surface of the deformable plate 109.

The rigid plate 111 and the deformable plate 109 both incorporate conductive materials. Suitable materials for forming the rigid plate 111 and the deformable plate 109 include semiconductors, for example silicon and germanium, ceramics, metals and metalloids. Silicon-based materials are generally preferred, however. The deformable plate 109 incorporates a material that permits it to be repeatedly deformed along at least the x and/or y directions. Suitable materials include elastically deformable polymer materials, for example, and conductive polymers. The conductive material in the rigid plate 109, which may be any of the exemplary materials listed above, could be embedded in or carried on the surface of the deformable material, for example as a foil or mesh.

The deformable plate 109 is connected to a first control circuit 119. The first control circuit 119 is configured to apply a voltage across the deformable plate 109, which can be controlled by the first control circuit 119 so as to heat the deformable plate 109 by resistive heating. The voltage applied by the first control circuit 119 can also be controlled so as to influence parameters such as the contact angle between the vapourisable liquid and the interior of the channels 109a, which in turn affect the rate at which the liquid is transported to the outlet surface 113 and the properties of the generated vapour. For example, when the deformable plate 109 is heated, the temperature of the liquid inside the first plurality of channels 109a increases. This typically increases the rate at which the vapour is generated.

Similarly, the rigid plate 111 is connected to a second control circuit 121. Like the first control circuit 119, the second control circuit 121 is configured to vary the voltage across the rigid plate 111 so as to control the temperature of the rigid plate 111 and parameters such as the contact angle between the vapourisable liquid and the first plurality of channels 111a. It is preferable that the deformable plate 109 is kept at a higher temperature than the rigid plate 111 where the rigid plate 111 and/or deformable plate 109 is heated. Hence, in this embodiment, each of the rigid plate 111 and the deformable plate 109 is a micro-electromechanical system (MEMS) that affords control over the rate at which the vapourisable liquid is transported to the outlet surface 113 and the properties of the generated vapour.

Although in this embodiment each of the rigid plate 111 and deformable plate 109 is provided with a separate control circuit, a single control circuit could be configured to control both plates in other embodiments.

The deformable plate 109 is coupled to an actuator 115, which can be advanced and retracted along the x direction, as indicated by the arrow 115a, such that the deformable plate 109 can be compressed and stretched in order to vary the cross-sectional area of the channels 109a in the x-y plane. Changing the cross-sectional area of the channels 109a affects the rate at which the vapourisable liquid travels through the channels 111a by capillary action, so the actuator 115 can be controlled to vary the rate at which the vapourisable liquid is transported to the outlet surface 113. This in turn can affect the size of the droplets in the generated vapour and the overall rate at which the vapour is produced.

FIG. 2(a) shows the structure of an exemplary deformable plate 201 suitable for use in embodiments of the invention. A plurality of channels 201a extends through the deformable plate 201. In this example, the deformable plate has a honeycomb structure, which is a cellular structure in which each of the channels 201a is hexagonal in cross-section. The deformable plate 201 may be formed of an elastically deformable material, in which case it will revert to the state shown in FIG. 2(a) when not subject to a deforming force, but this is not essential.

FIG. 2(b) shows a plan view of the deformable plate 201 in the state shown in FIG. 2(a). Here the hexagonal cross-sections of the channels 201a are clearly visible.

FIG. 2(c) shows a plan view of the deformable plate 201 while compressed along the y direction. When this structure is deformed in this way, the channels 201a each decrease in width along the y direction and extend along the x direction. As a result, the cross-sectional area of each of the channels 201a is reduced relative to the rest state shown in FIG. 2(b).

FIG. 2(d) shows the deformable plate 201 subject to a greater degree of deformation than in FIG. 2(c).

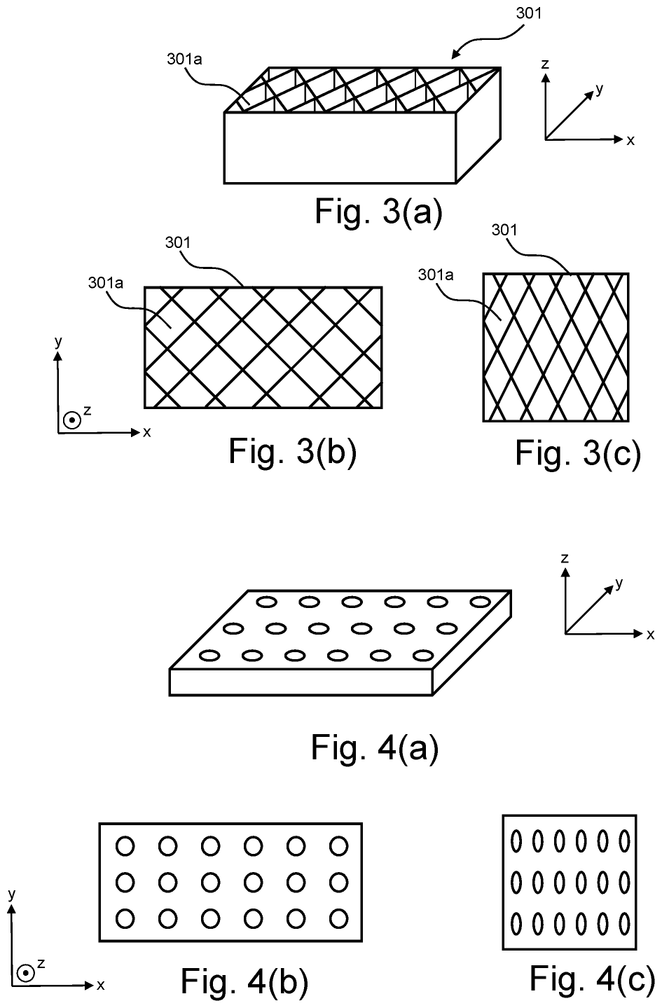

FIG. 3(a) shows a second exemplary structure of a deformable plate 301 suitable for use in embodiments of the invention. In this example, the deformable plate 301 has a cellular structure that is a truss structure. Like in the examples discussed above, a plurality of channels 301a extend through the deformable plate 301 along the z direction. Due to the truss structure, each of the channels 301a is quadrilateral in cross section. FIG. 3(a) shows the deformable plate 301 in an undeformed state, in which the cross-sectional area of each of the channels 301a is maximised.

FIG. 3(b) shows a plan view of the deformable plate 301 in the same state as is shown in FIG. 3(a). FIG. 3(c) shows a plan view of the deformable plate 301 when deformed by compression along the x direction. The cross-sectional area (in the x-y plane) of each of the channels 301a is less than when the deformable plate is in the undeformed state.

FIG. 4(a) shows a third exemplary structure of a deformable plate 401 suitable for use in embodiments of the invention. Again, a plurality of channels 401a extend through the deformable plate 401 along the z direction. Unlike the examples shown in FIGS. 2(a)-(d) and 3(a)-(c), however, the deformable plate 401 does not have a cellular structure. Instead, the channels 401a are formed by cylindrical through-holes in an otherwise solid plate 401. In this example, the channels 401a are arranged in a regular array (specifically a square array) and each have the same diameter.

FIG. 4(b) shows a plan view of the deformable plate 401. When the deformable plate 401 is in its undeformed state, each of the channels 401a is substantially circular in cross-section. FIG. 4(c) shows a plan view of the deformable plate 401 when compressed along the x direction. When the deformable plate is compressed in this manner, the channels 401a become elliptical and their cross-sectional area (in the x-y plane) is reduced relative to when in the undeformed state.

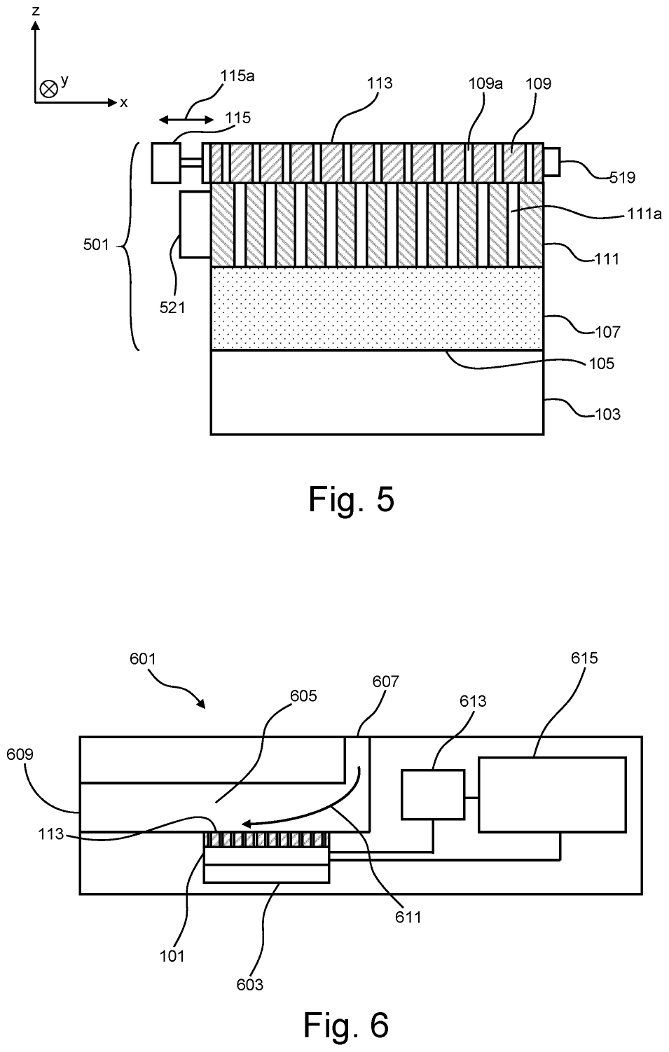

FIG. 5 is a cross-sectional view of an evaporator assembly 501 in accordance with a second embodiment of the first aspect of the invention. The evaporator assembly 501 includes all of the components of the evaporator assembly 101 of FIG. 1 described above except for the first control circuit 119 and the second control circuit 121. Instead of the control circuits, heat is supplied to deformable plate 109 by a first heater 519. The first heater 519 can be electrically powered (for example by a battery of a vapour generation device in which the evaporator assembly is contained) and controlled by an electronic controller. Similarly, the rigid plate 111 is provided with a second heater 521, which may also be electrically powered and controlled by an electronic controller.

In this example each of the rigid plate 109 and the deformable plate 111 is provided with a respective heater, though this is not essential. For example, the second heater 521 could be omitted such that only the deformable plate 109 is provided with a heater. In other embodiments, both the rigid plate 109 and deformable plate 109 could be heated by a single heater. In embodiments where the deformable plate 109 is heated (whether the rigid plate 111 is heated or otherwise), it is preferable that the deformable plate 109 is kept at a higher temperature than the rigid plate 111 when the evaporator assembly 101 is in use.

FIG. 6 shows schematically a vapour generation device 601 in accordance with the second aspect of the invention. An airflow channel 605 extends through the vapour generation device 601, and the evaporator assembly 101 described above is arranged such that the outlet surface 113 is exposed to the interior of the airflow channel 605. The evaporator assembly receives a vapourisable liquid from a reservoir 603.

Air can be drawn into the airflow channel 605 through an inlet 607 and travel through the airflow channel along the direction indicated by the arrow 611. As the air passes the outlet surface 113 of the evaporator assembly, droplets of the vapourisable liquid are drawn away from the outlet surface 113 by the airflow. This produces a vapour of the vapourisable liquid. The vapour continues to travel along the airflow channel 605 and exits the vapour generation device via an outlet 609. The outlet could be provided with a mouthpiece, allowing the airflow to be generated by a user drawing on the device 601 at the mouthpiece.

In this example, the evaporator assembly 101 is in communication with an electronic controller 613. The electronic controller 613 can be configured to control components of the evaporator assembly including the actuator 115, the first control circuit 119 and the second control circuit 121. Indeed, the electronic controller 613 could incorporate the control circuits 119, 121. The electronic controller can also be configured to control other components of the vapour generation device 501. The vapour generation device 501 also has a power source 515, for example a rechargeable battery. The power source is configured to supply power to the components of the evaporator assembly 101 and the electronic controller 513, and can also power other components of the vapour generation device 501, for example valves and reheaters in the airflow channel or lights for displaying information about the operation of the device 501.

The evaporator assembly 101 in this exemplary vapour generation device 501 could be replaced by the evaporator assembly 501 of FIG. 5. In that case, the electronic controller 513 could be configured to control the heaters 119, 121 in addition to, or as an alternative to, controlling the bias applied to the deformable plate 109 and the rigid plate 111.

1. An evaporator assembly for a vapour generation device, the evaporator assembly comprising:
a deformable plate in which is formed a first plurality of channels for transporting a vaporisable liquid through the deformable plate to an outlet surface of the evaporator assembly, wherein the deformable plate is configured such that in use the cross-sectional area of each of the first plurality of channels varies as the deformable plate is deformed.

2. The evaporator assembly of claim 1, further comprising an actuator arranged to deform the deformable plate when the actuator is operated.

3. The evaporator assembly of claim 2, wherein the actuator is configured to deform the deformable plate by one or more of stretching, compressing or shearing the deformable plate along a direction perpendicular to the first plurality of channels.

4. The evaporator assembly of claim 1, wherein the first plurality of channels is defined by a cellular structure in the deformable plate.

5. The evaporator assembly of claim 1, wherein the first plurality of channels is arranged in a regular array.

6. The evaporator assembly of claim 1, wherein each of the first plurality of channels is adapted to transport the liquid through the deformable plate by capillary action.

7. The evaporator assembly of claim 1, further comprising a first heater arranged to heat the deformable plate.

8. The evaporator assembly of claim 7, wherein the first heater comprises an electrical source configured to generate a current through the deformable plate so as to cause resistive heating of the deformable plate.

9. The evaporator assembly of claim 1, further comprising a rigid plate in which is formed a second plurality of channels for transporting the vaporisable liquid through the rigid plate, wherein the rigid plate and the deformable plate overlap one another such that the second plurality of channels is in fluid communication with the first array of channels.

10. The evaporator assembly of claim 9, wherein each of the second plurality of channels is adapted to transport the liquid through the rigid plate by capillary action.

11. The evaporator assembly of claim 9, wherein the deformable plate is disposed directly on the rigid plate.

12. The evaporator assembly of claim 10, further comprising a second heater arranged to heat the rigid plate.

13. The evaporator assembly of claim 1, wherein the outlet surface is a surface of the deformable plate.

14. A vapour generation device comprising:
the evaporator assembly of claim 1; and
a reservoir for storing the vaporisable liquid, wherein the evaporator assembly is arranged to receive the vaporisable liquid from the reservoir.

15. The vapour generation device of claim 14, further comprising a porous wick arranged to transport the liquid from the reservoir to the evaporator assembly.

16. The evaporator assembly of claim 4, wherein the cellular structure is a honeycomb, truss, or Kirigami-based cellular structure.
